(19) United States
(12) Patent Application Publication
(10) Pub. No.: US 2006/0094297 A1
(43) Pub. Date: May 4, 2006

(54) Terminal structure of a coaxial connector

(75) Inventor: Jian Zhong Wang, Taipei (TW)

Correspondence Address: MICHAEL LIN, 5F 79 Roosevelt Rd. Sec. 2, TAIPEI, 106, TW

(73) Assignee: ADVANCED CONNECTEK INC., Taipei (TW)

(21) Appl. No.: 10/906,504

(22) Filed: Feb. 23, 2005

(30) Foreign Application Priority Data
Oct. 29, 2004 (TW) 93217327

(51) Int. Cl. H01R 9/05

(52) U.S. Cl. 439/578

(57) ABSTRACT

An improved terminal structure of a coaxial cable connector, especially a terminal structure with bendable leg portions in the coaxial cable connector, by connecting the said leg portion of the terminal structure to the central conductor of the coaxial cable, the connection between said terminal structure and central conductor is able to be held firmly, therefore better enhances a smooth electrical signal transmission between the connectors.

### BACKGROUND OF THE INVENTION

1. Field of the Invention

The present invention relates to an improved terminal structure of a coaxial cable connector, especially a terminal structure that uses a clamp to connect the conductor of a coaxial cable connector.

2. Description of the Prior Art

Coaxial cable connector is a widely used cable connector for transmitting radio frequency signal. Conventional coaxial cable connector is an L-shaped body in general, comprising a conductive shell, an insulating housing, a central terminal which is connected to a coaxial cable and a connecting portion at one end of central terminal; prior to assembly, a conductive shell comprising of a circular substrate and a shielding piece stands vertically; while in assembly, the central terminal and the central conductor of the coaxial cable assembly connected to the connecting portion are inserted into the insulating housing first, after the insertion, the insulating housing is placed into the circular substrate of the conductive shell, then the shielding piece is bent at a 90 degree angle to wrap up and cover the insulating housing; in addition, several side wings located at the front end of the shielding piece also provide added protection by wrapping around the coaxial cable assembly.

Conventional method to mount the terminal onto the coaxial cable conductor is by soldering. However, the conventional method has the following drawbacks or disadvantages. That is, it is very difficult to solder the central conductor to the central terminal within a small space in the insulating housing, resulting in frequent defective soldering. In addition, the separate conductive shell increases the number of assembly steps and thus the manufacturing cost.

### SUMMARY OF THE INVENTION

It is an object of the present invention to provide an improved terminal structure of a coaxial cable connector comprising a terminal having a clamp structure for better clamping of the central conductor of a coaxial cable onto the terminal. The clamp structure can be of a bendable arm or a clamp, thus providing an improved terminal structure, which could connect the conductor of the coaxial cable onto the terminal without soldering.

To achieve the above object, the present invention provides an improved terminal structure of a coaxial cable connector comprising a conductive shell and an central terminal, the terminal comprises of a bending portion, a base plate and a plurality of contact pieces, the base plate connects the bending portion on one side and extends into an engaging portion on the other side, the lower part of the base plate connects to said plurality of contact pieces, the bending portion comprises a substrate having a plurality of bendable leg portions, the leg portion and the substrate defines the clamping portion, the central conductor of the coaxial cable could be placed into the clamping portion, the leg portion is bent toward the substrate to make the central conductor and the bending portion engage with each other, thus ensuring a smooth circuit signal transmission.

The conductive shell includes a shielding piece and a circular substrate, shielding piece is divided into a first locking piece and a second locking piece, said first locking pieces are generally used to cover the insulating housing and the retaining slot thereof inside the circular substrate, said second locking piece is used for holding the electrical conductor of the coaxial cable; the insulating housing is a cylindrical body, having a round opening on the bottom and a square terminal insertion hole on the top, an opening which connects electrical conductor is located on a side of the insertion hole, a fixing piece extending out from a sidewall which is used for holding the terminal and the electrical conductor within the therein housing and to maintain stability of connection is located on the other side of the body; the terminal is a square-shaped body, on one side of the terminal is a pair of contact pieces which extends outwardly from the sidewalls of the body and bends slightly toward one of its side edge, on the other side of the body is a terminal bearing portion, said terminal bearing portion can be comprises a bent-mode or a clamp-mode, the terminal bearing portion is used for engaging the electrical conductor with the terminal firmly in a bent-mode or a clamp-mode to ensure circuit signal transmission.

The above object, features and advantages of the present invention will become apparent from the following detailed description taken with the accompanying drawings.

### BRIEF DESCRIPTION OF DRAWINGS

FIG. 1 is a perspective view of the embodiment of the invention in a first state.

FIG. 2 is a perspective view of the embodiment of the invention in a second state.

FIG. 3 is an exploded perspective view of the embodiment of the invention.

FIG. 4 is a perspective view of a first embodiment of the invention.

FIG. 5 is another perspective view of a first embodiment of the invention.

FIG. 6 is a perspective view of a second embodiment of the invention.

FIG. 7 is another perspective view of a second embodiment of the invention.

FIG. 8 is an application view of a first embodiment of the invention.

FIG. 9 is an application view of a second embodiment of the invention.

### DETAILED DESCRIPTION OF THE PREFERRED EMBODIMENT

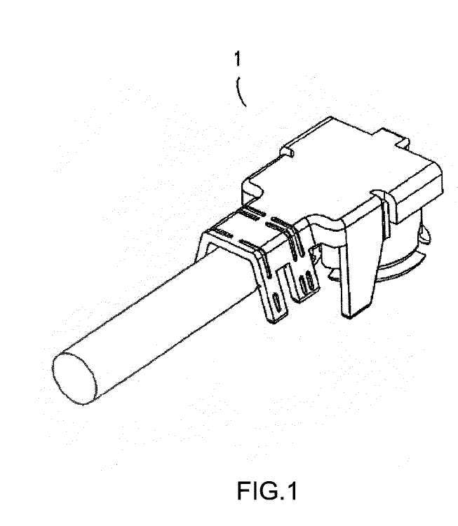

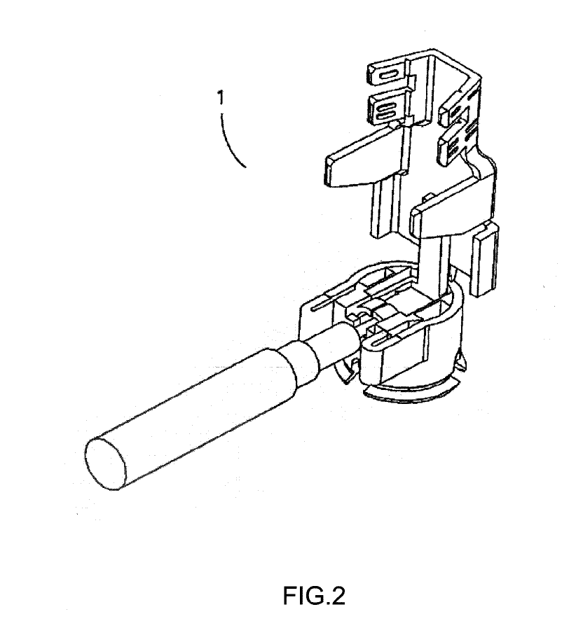

Please refer to FIGS. 1-5, which show a first embodiment of the improved structure of the cable connector according to the invention, the improved structure of the cable connector in the invention is a clamp-mode terminal structure, which is used in coaxial cable connector 1; as shown in FIGS. 1-3, the coaxial cable connector is mainly consisting of a conductive shell 2, an therein housing 3, a clamp-mode terminal 4, thereof, the conductive shell 2 and the therein housing 3 are of the prior arts, so only given a brief description thereto:

The conductive shell 2 includes a shielding piece 21 and a substrate 22, the shielding piece 21 has first locking pieces 212 and a plurality of second locking pieces 213 bending out from the body portion 210 thereof, the first locking pieces are used for holding the braid portion 53 of the coaxial cable, and the second locking pieces 213 are used for holding the outer therein layer 54, the body portion 210 has vertically bent cover pieces 211 adjacent to the substrate 22, the substrate 22 of the conductive shell 2 is an unitarily formed pillar body, the body is generally like a circular tube 221, the circular tube 221 opens bent walls 222 bending inward on an end, and the circular tube 221 has a guarding piece 223 bending outward slightly on the other end, around the guarding piece 223 having a plurality of notches 224, in the middle of the substrate 22 having a hollow portion 225 which will be covered by the conductive shell 2 for disposing the therein housing 3 and the terminal 4.

The lower portion of the body 32 of the therein housing 3 has a base portion 31, on the bottom of the base portion 31 having an aperture, in the middle of the body 32 having a terminal insertion hole 321, the terminal insertion hole 321 communicates with the above said aperture, the insertion hole 321 extends forward and forms into an opening 323, on the two sides of the body 32 having a recess 322 respectively, the body 32 has a fixing piece 324 extending upward on the opposite side edge of the opening 323, after the therein housing 3 is inserted into the substrate 22 of the conductive shell 2, the fixing piece 324 could be bent at a right angle to cover the insertion hole 321 to achieve a safeguard effect.

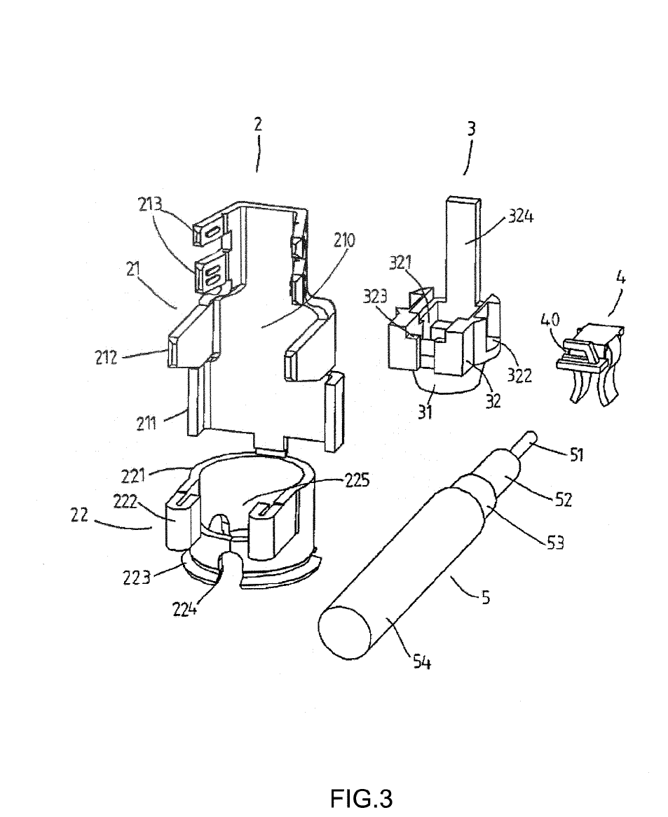

As shown in FIG. 3, the coaxial cable 5 includes a central conductor 51 and a braid portion 53, between the central conductor 51 and the braid portion 53 having an inner therein layer 52 and an outer edge of the braid portion 53 wrapped by an outer therein layer 54.

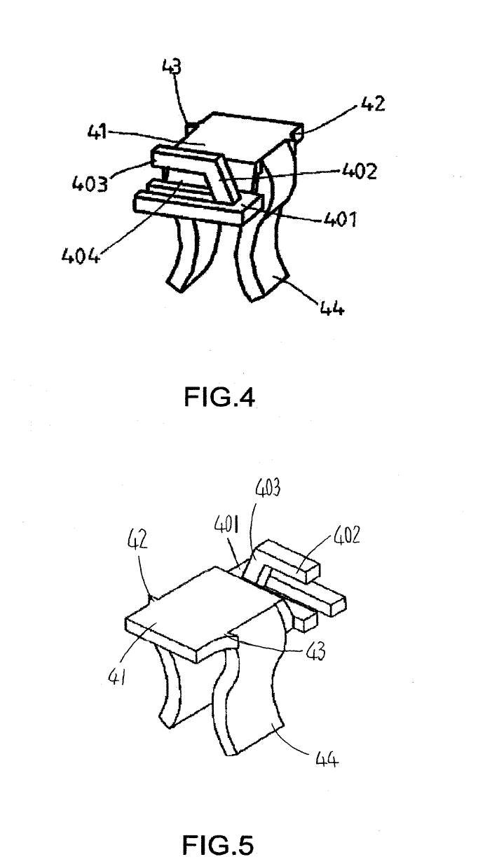

In the invention, the main point of the improved structure of the coaxial cable connector terminal is the improvement of the terminal, thus given a detailed description of it thereafter; please refer to FIGS. 4 and 5, which show a first embodiment of the invention, the terminal 4 generally consists of a bending portion 40, a base plate 41, and two contact pieces 44, the base plate 41 connects to the bending portion 40 on one side, and the other side extends and forms into an engaging portion 42, on the two sides of the engaging portion 42 having spurs 43, below the two sides of the base plate 41 having contact pieces 44 extending downward and slightly bending inward used for making electrical connection with a mating terminal, on the above said bending portion 40 having a substrate 401, the center of the substrate 401 extends upward to connect a bendable leg portion 403 through a convex arm 402, the leg portion 403 and the substrate 401 defines a clamping portion 404, the central conductor 51 of the coaxial cable could be rested on the clamping portion 404, then the leg portion 403 is bent toward the substrate 401 by tool, cause the bending portion 40 make electrical connection with the central conductor 51.

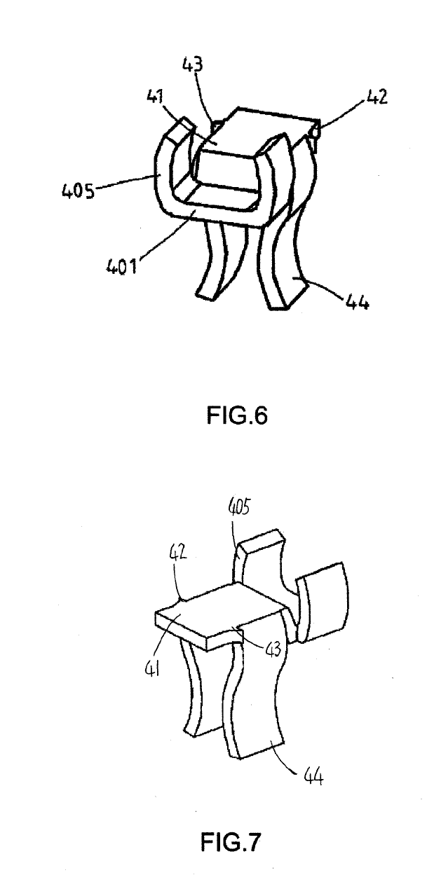

The clamp-mode terminal 4 of the invention also could be embodied in other ways, please refer to FIGS. 6 and 7, the terminal consists of a bending portion 40, a base plate 41, and two contact pieces 44, the base plate 41 connects to the bending portion 40 on one side, and the other side extends and forms into an engaging portion 42, on the two sides of the engaging portion having spurs 43, below the two sides of the base plate 41 having contact pieces 44 which extend downward and then bend inward slightly, the contact pieces 44 are used for making electrical connection with a mating terminal, on the above said bending portion 40 having a substrate 401, the two side edges of the substrate 401 extend upward and form a bendable leg portion 405 respectively, then the leg portions 405 are bent toward the substrate 401, cause the bending portion 40 make electrical connection with the central conductor 51.

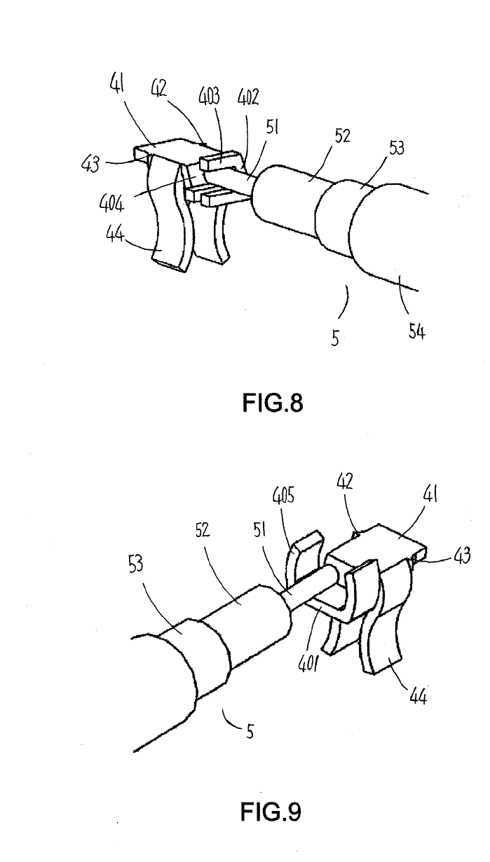

Please refer to FIGS. 1, 2, 3, 8 and 9, the assembly steps of the coaxial cable connector of the invention are described in the following:

Step 1, insert the central conductor 51 of the coaxial cable 5 into the clamping portion 404 of the clamp-mode terminal 4, press the leg portion 403 and 405 toward the center of the substrate 401 by means of an automatic producing tool with the central conductor 51 is held on the substrate 401.

Step 2, place the clamp-mode terminal 4 into the terminal insertion hole 321 of the therein housing 3 with the bending portion 40 facing the opening 323 on a side of the therein housing 3.

Step 3, face the fixing piece 324 of the therein housing 3 at the centerline of the first locking piece 212 or the second locking piece 213 on two sides of the shielding piece 21, then place into the hollow portion 225 of the substrate 22.

Step 4, after the therein housing 3 and the terminal 4 are inserted, bend the shielding piece 21 of the conductive shell 2 in a direction toward the substrate 22, in doing so the fixing piece 324 will also be bent to cover and stabilize the therein housing 3, the clamp-mode terminal 4 and the central conductor 51.

Step 5, the first locking pieces 212 of the shielding piece 21 are bent toward each side so as the braid portion 53 of the coaxial cable 5 could be held firmly, and the outer therein layer 54 of the coaxial cable 5 is held by the second locking pieces 213 surely.

The mode utilized in the invention lies in the central conductor of the coaxial cable could be held firmly by means of a conductor clamping design in the bending portion of the clamp-mode terminal to achieve the maximum effect of the connector.

While the invention herein disclosed has been described by means of specific embodiments, numerous modifications and variations could be made thereto by those skilled in the art without departing from the scope and spirit of the invention set forth in the claims.

What is claimed is:

1. An improved terminal structure of a coaxial cable connector, comprising:
a clamp section having a substrate and a plurality of bendable leg portions;
a base plate having said clamp connected to one side and an engaging portion to the other side;
a plurality of contact pieces connected to the bottom of said base plate.

2. An improved terminal structure of a coaxial cable connector according to claim 1, wherein said engaging portion has a plurality of spurs on the two sides thereof.

3. An improved terminal structure of a coaxial cable connector according to claim 1, wherein said leg portion is formed by protruding an arm piece from the center of said substrate upward with an angle extending thereof.

4. An improved terminal structure of a coaxial cable connector according to claim 1, wherein said leg portion is formed by extending said leg portion upward from the two side edges of said substrate respectively.
